(19) United States
(12) Patent Application Publication
(10) Pub. No.: US 2009/0147509 A1
(43) Pub. Date: Jun. 11, 2009

(54) CONFIGURABLE LED LIGHTING STRIP

(76) Inventors: Daniel P. Reed, Warren, MI (US); Matthew Mark Mikolajczak, Novi, MI (US)

Correspondence Address: FRASER CLEMENS MARTIN & MILLER LLC, 28366 KENSINGTON LANE, PERRYSBURG, OH, 43551, US

(21) Appl. No.: 11/952,549

(22) Filed: Dec. 7, 2007

(51) Int. Cl. F21V 19/00; H01R 43/00; F21V 23/04; F21V 33/00; F21V 19/02

(52) U.S. Cl. 362/234; 362/418; 29/854; 362/382

(57) ABSTRACT

A lighting system and method for assembling the lighting system are disclosed, wherein the lighting system includes a flexible conductive strip, a control module in electrical communication with the flexible conductive strip, and a plurality of light source modules, wherein the light source modules can be coupled to the lighting system at any desired location along the length of the flexible conductive strip.

### FIELD OF THE INVENTION

The present invention relates to a lighting system. More particularly, the invention is directed to a configurable LED light system and a method of assembling the light system.

### BACKGROUND OF THE INVENTION

Light emitting diodes (LEDs) are increasingly being used in a wide variety of applications including vehicle lighting, flashlights, traffic signals, backlighting, and emergency lighting, for example. LED packages are energy efficient, reliable, and long lasting, making a lighting unit that incorporates an LED package, desirable in many lighting applications.

Currently, many lighting applications incorporate LEDs that are soldered to a printed circuit board. The soldering of the LEDs requires fixed placement and does not permit variability to adjust for specific lighting needs. Other applications, such as automobile applications, may require a flexible lighting system. In the flexible lighting system, LEDs may be fixed onto a flexible wiring system at predetermined locations, and then the lighting system is placed into a desired location. The flexible lighting system provides the freedom to adjust for specific lighting needs. However, many applications require post installation adjustments such as additional LEDs, for example. If an adjustment needs to occur, the flexible wiring must be bent or cut to adjust for additional LEDs. The post-installation adjustment process is time consuming and inefficient. There is a need for a lighting system, wherein post-installation adjustments are simple and efficient.

It would be desirable to have a lighting system and method of assembling the lighting system, wherein a light source may be coupled to the lighting system at any location along a flexible conductive strip, the flexible conductive strip providing electrical communication between the light source and a control module.

### SUMMARY OF THE INVENTION

Concordant and consistent with the present invention, a lighting system and method of assembling the lighting system, wherein a light source may be coupled to the lighting system at any location along a flexible conductive strip, the flexible conductive strip providing electrical communication between the light source and a control module, has surprisingly been discovered.

In one embodiment, a light source module comprises a first portion, a second portion hingedly connected to the first portion, a light source disposed on one of the first portion and the second portion, and a plurality of conductive leads disposed on one of the first portion and the second portion, the conductive leads adapted to provide electrical communication between the light source and a source of electrical power.

In another embodiment, a lighting system comprises a flexible conductive strip; a plurality of light source modules including a first portion, a second portion, a light source and a plurality of conductive leads, wherein the conductive leads provide electrical communication between the light source and the flexible conductive strip; and a control module in electrical communication with the flexible conductive strip.

The invention also provides methods for assembling a lighting system.

One method comprises the steps of providing a flexible conductive strip; providing a plurality of light source modules including a first portion, a second portion, a light source and a plurality of conductive leads; disposing the flexible conductive strip between the first half and the second half of each of the light source modules; and crimping the conductive leads of the light source module to provide electrical communication between the flexible conductive strip and the light source.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a lighting system according to an embodiment of the present invention.

FIG. 2 is a perspective view of a light source module illustrated in FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

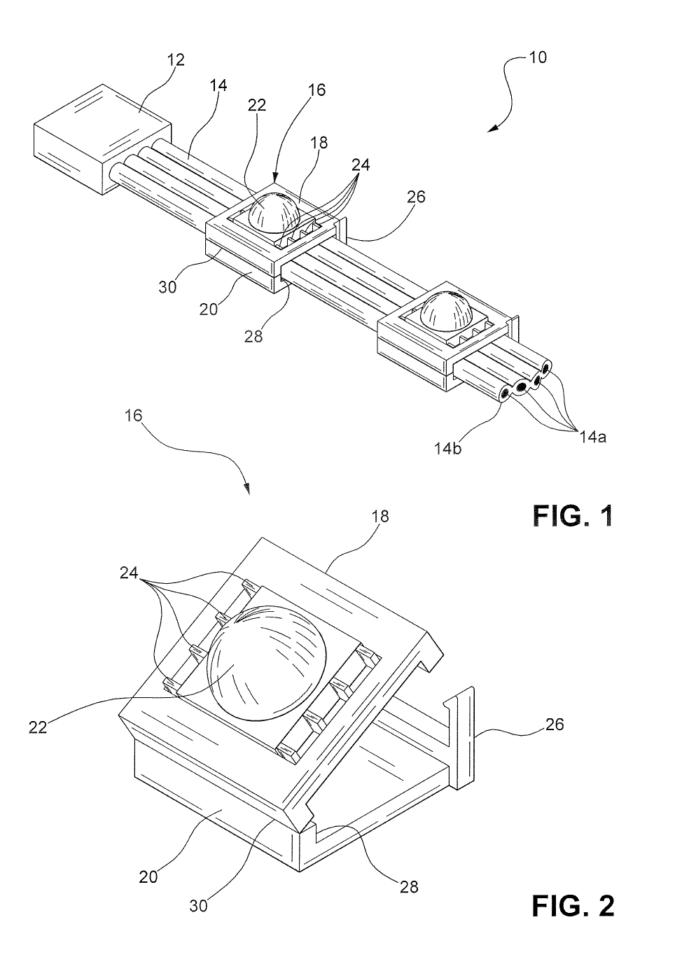

FIG. 1 shows a lighting system 10 according to an embodiment of the present invention. The lighting system 10 includes a control module 12, a flexible conductive strip 14, and a light source module 16.

The control module 12 is in electrical communication with the flexible conductive strip 14. It is understood that the control module 12 may be any conventional controller such as a computer controller, for example. It is further understood that the control module 12 may include any conventional means for securing the control module 12 to a desired surface such as a harness, for example.

The flexible conductive strip 14 may be any conventional conductor cable such as an insulated ribbon cable and a flexible flat conductor cable (FFC), for example. Although the flexible conductive strip 14 is shown in electrical communication with the control module 12, it is understood that the flexible conductive strip 14 may be in electrical communication with any conventional electrical component such as an electrical energy source, for example. The flexible conductive strip 14 includes a plurality of conductive wires 14a disposed in a non-conductive insulative material 14b.

The light source module 16 includes a first portion 18, a second portion 20, a light source 22, a plurality of conductive leads 24, and a means for coupling 26 the first portion 18 to the second portion 20. The light source 22 may be any conventional light source such as a light emitting diode (LED) and a tricolored LED, for example. The light source 22 is in electrical communication with the conductive leads 24. In FIGS. 1 and 2, the light source 22 is disposed on the first portion 18 of the light source module 16. It is understood that the light source 22 may be disposed on any portion of the light source module 16, as desired.

The conductive leads 24 are formed from any conventional conductive material such as metal, for example. The conductive leads provide electrical communication between the light source 22 and the conductive wires 14a of the flexible conductive strip 14. It is understood that the conductive leads 24 may provide any electrical circuitry pattern, as desired. In FIGS. 1 and 2, the conductive leads 24 are disposed on the first portion 18 of the light source module 16. In FIG. 1, the conductive leads 24 are shown in a crimped position. It is understood that the conductive leads 24 may be disposed on any portion of the light source module 22, as desired.

The means for coupling 26 the first portion 18 of the light source module 16 to the second portion 20 of the light source module 16 may be any conventional means such as a detent for example. FIG. 1 shows the light source module 16 in the “closed” position, wherein the flexible conductive strip 14 is disposed between the first portion 18 and the second portion 20. FIG. 2 shows the light source module 16 in the “open” position. As shown, the light source module 16 includes a cable path 28 formed therein. A living hinge 30 hingedly connects the first portion 18 to the second portion 20. Other hinge structures can be used as desired.

In use, the control module 12 is secured in a desired location. It is understood that the control module 12 may be secured using any conventional method such as a harness, for example. The flexible conductive strip 14 is disposed along a desired path. The flexible conductive strip 14 may be coupled to a desired surface by any conventional means such as an adhesive and wire clips, for example. The light source module 16, in the “open” position, is disposed adjacent the flexible conductive strip 14 at any desired position along the length thereof. The flexible conductive strip 14 is disposed between the first portion 18 and the second portion 20 of the light source module 16. In the embodiment shown, the flexible conductive strip 14 is disposed in the cable path 28. The first portion 18 is closed on and coupled to the second portion 20 to position the light source module 16 in the “closed” position.

The conductive leads 24 are then crimped to provide electrical communication between the conductive wires 14a of the flexible conductive strip 14 and the light source 22 of the light source module 16. It is understood that during the crimping operation, the conductive leads 22 may pierce the insulating material 14b of the flexible conductive strip 14 to make an electrical connection to the conductive wires 14a of the flexible conductive strip 14. It is further understood that the crimping operation may be any conventional crimping operation such as a sliding and a bending of the conductive leads 24, for example. Although the embodiment shown in FIG. 1 shows two light source modules 16, it is understood that any number of light source modules 16 may be disposed along the flexible conductive strip 14. The control module 12 provides electrical control of each light source module 16 in electrical communication with the flexible conductive strip 14. It is understood that the light source modules 16 may be disposed on the flexible conductive strip 14 before the flexible conductive strip 14 is disposed along the desired path.

The lighting system 10 and method of the present invention provide a simple and efficient means for coupling the light source 22 to the lighting system 10. The lighting system 10 and method eliminates the need for a complex post-installation adjustment procedure. The present invention provides the freedom to couple the light source 22 at any position along the length of the flexible conductive strip 14, while minimizing any bending or cutting of the flexible conductive strip 14.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A light source module comprising:
a first portion;
a second portion hingedly connected to the first portion;
a light source disposed on one of the first portion and the second portion; and
a plurality of conductive leads disposed on one of the first portion and the second portion, the conductive leads adapted to provide electrical communication between the light source and a source of electrical power.

2. The light source module according to claim 1, wherein the light source is a light emitting diode.

3. The light source module according to claim 1, wherein the conductive leads are crimped to provide electrical communication between the light source and the source of electrical power.

4. The light source module according to claim 1, wherein the light source module further comprises a detent for coupling the first portion and the second portion.

5. A lighting system comprising:
a flexible conductive strip;
a plurality of light source modules including a first portion, a second portion, a light source, and a plurality of conductive leads, wherein the conductive leads provide electrical communication between the light source and the flexible conductive strip; and
a control module in electrical communication with the flexible conductive strip.

6. The light system according to claim 5, wherein the flexible conductive strip is one of an insulated ribbon cable and a flat insulted wire.

7. The light system according to claim 5, wherein the light source is a light emitting diode.

8. The light system according to claim 5, wherein the conductive leads are crimped to provide electrical communication between the light source and the flexible conductive strip.

9. The light system according to claim 5, wherein at least one of the light source and the conductive leads is disposed on the first portion of the light source module.

10. The light system according to claim 5, wherein each of the light source modules further comprises a means for coupling the first portion of the light source module and the second portion of the light source module.

11. The method according to claim 10, wherein the means for coupling the first portion of the light source module and the second portion of the light source module is a detent.

12. The method according to claim 5, wherein the first portion and the second portion are hingedly connected by a living hinge.

13. A method of assembling a lighting system, the method comprising the steps of:
providing a flexible conductive strip;
providing a light source module including a first portion, a second portion, a light source and a plurality of conductive leads;
disposing the flexible conductive strip between the first portion and the second portion of the light source module; and
crimping the conductive leads of the light source module to provide electrical communication between the flexible conductive strip and the light source.

14. The method according to claim 13, wherein the flexible conductive strip is one of an insulated ribbon cable and a flat insulted wire.

15. The method according to claim 13, wherein the light source is a light emitting diode.

16. The method according to claim 13, further comprising the step of providing a control module in electrical communication with the flexible conductive strip.

17. The method according to claim 13, wherein at least one of the light source and the conductive leads is disposed on the first portion of the light source module.

18. The method according to claim 13, wherein the light source module includes a means for coupling the first portion and the second portion.

19. The method according to claim 18, wherein the means for coupling the first portion and the second portion is a detent.

20. The method according to claim 13, wherein the first portion and the second portion are hingedly connected by a living hinge.
